(19) United States
(12) Patent Application Publication
(10) Pub. No.: US 2026/0121675 A1
(43) Pub. Date: Apr. 30, 2026

(54) SYSTEMS AND METHODS FOR ENHANCED AUTOMATIC GAIN CONTROL WITH DYNAMIC HYSTERESIS ALGORITHM

(71) Applicant: Avago Technologies International Sales Pte. Limited, Singapore (SG)

(72) Inventors: Bo YE, Saratoga, CA (US); Kadir DINC, Irvine, CA (US); Hongtao JIANG, Aliso Viejo, CA (US); Xiaochen YANG, Irvine, CA (US); Kalyan KANKIPATI, Irvine, CA (US); Yong LIU, Irvine, CA (US)

(73) Assignee: Avago Technologies International Sales Pte. Limited, Singapore (SG)

(21) Appl. No.: 18/931,338

(22) Filed: Oct. 30, 2024

(51) Int. Cl. H04B 1/16

(52) U.S. Cl. CPC H04B 1/16

(57) ABSTRACT

In some implementations, an apparatus for processing one or more signals may include an amplifier and circuitry. The circuitry may be coupled to the amplifier. The circuitry may set a first threshold indicating a first signal strength which is a positive value, and a second threshold indicating a second signal strength greater than the first threshold. The circuitry may receive a signal having a signal strength varying over time. The circuitry may enter a first state and start a timer set to a first time period. In response to the first time period ending, the circuitry may switch to a second state. In the second state, the circuitry may determine that the signal strength of the signal is greater than the second threshold, decrease a gain of the amplifier, and switch to the first state.

### FIELD OF THE DISCLOSURE

This disclosure generally relates to systems and methods for automatic gain control (AGC) operations for a communications system (e.g., wireless receiver system), including but not limited to systems and methods of performing AGC operations using hysteresis functions with state machines.

### BACKGROUND

Automatic gain control (AGC) is performed in many electronic circuits to regulate the signal strength of a received signal at the input of analog-to-digital converters (ADCs) to meet the required signal-to-noise ratio (SNR). When the signal strength of the received signal is weak (e.g., lower than a threshold), the AGC can increase the receiver gain to minimize noise and elevate the signal level to an acceptable SNR. Conversely, if the signal strength is strong (e.g., higher than a threshold), the AGC can decrease the receiver gain to prevent signal clipping, which can cause nonlinear degradation and deteriorate the SNR. Due to the inherent delay in an analog circuit, these gain adjustments may not align perfectly, potentially introducing small glitches during gain transitions.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a diagram depicting an example communication environment with communication systems, according to one or more embodiments.

FIG. 2 is a schematic block diagram of a computing system, according to one or more embodiments.

FIG. 3 is a block diagram depicting an example data path in a subsystem performing an AGC function in a wireless communication system, according to one or more embodiments.

FIG. 4 is a diagram depicting example ADC operations using a hysteresis function according to one or more embodiments.

FIG. 5 is a block diagram depicting an example data path in a subsystem performing an AGC function in a wireless communication system, according to one or more embodiments.

FIG. 6A to 6C are diagrams depicting an example of state machines and a hysteresis function for performing ADC operations according to one or more embodiments.

FIGS. 7A and 7B are diagrams depicting another example of a state machine and a hysteresis function for performing ADC operations according to one or more embodiments.

FIG. 8 is a block diagram depicting an example simulation system for simulating AGC operations in a receive (RX) side (RX AGC operations), according to one or more embodiments.

FIG. 9 is a diagram depicting an example simulation configuration for simulating RX AGC operations, according to one or more embodiments.

FIG. 10A to FIG. 10C are diagrams depicting example simulation results of RX AGC operations with different modes, according to one or more embodiments.

FIG. 11A is a diagram depicting an example gated AGC clock with enhanced receiver spur performance, according to one or more embodiments.

FIG. 11B is a diagram depicting example clock signals when using the gated AGC clock shown in FIG. 11A, according to one or more embodiments.

FIG. 12 is a flow diagram showing a process for processing one or more signals (e.g., performing AGC operations) using hysteresis functions with state machines in accordance with an embodiment.

The details of various embodiments of the methods and systems are set forth in the accompanying drawings and the description below.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, a first feature in communication with or communicatively coupled to a second feature in the description that follows may include embodiments in which the first feature is in direct communication with or directly coupled to the second feature and may also include embodiments in which additional features may intervene between the first and second features, such that the first feature is in indirect communication with or indirectly coupled to the second feature. In addition, the present disclosure may repeat reference numerals and/or letters in the various examples. This repetition is for the purpose of simplicity and clarity and does not in itself dictate a relationship between the various embodiments and/or configurations discussed.

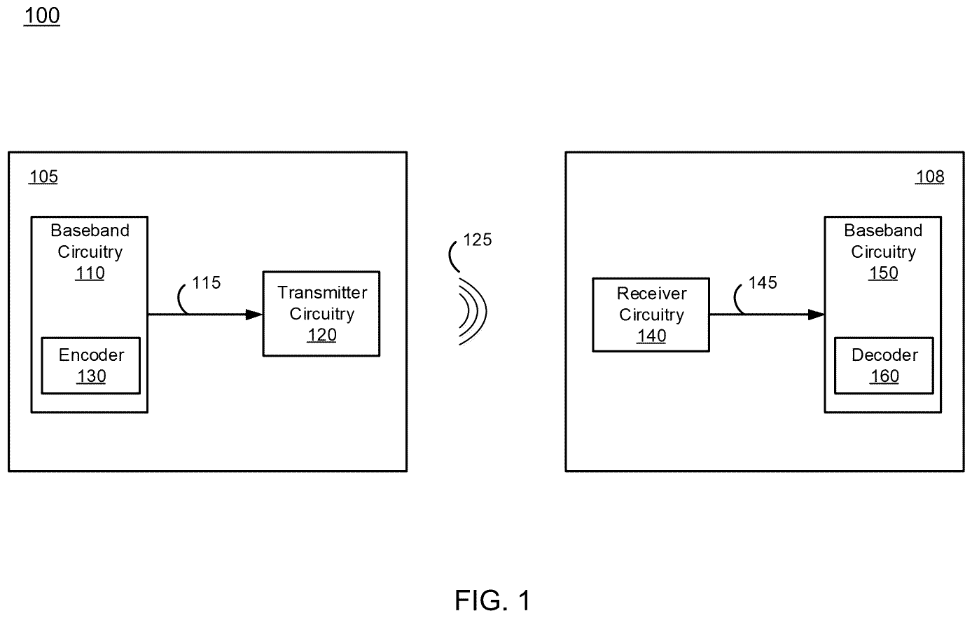

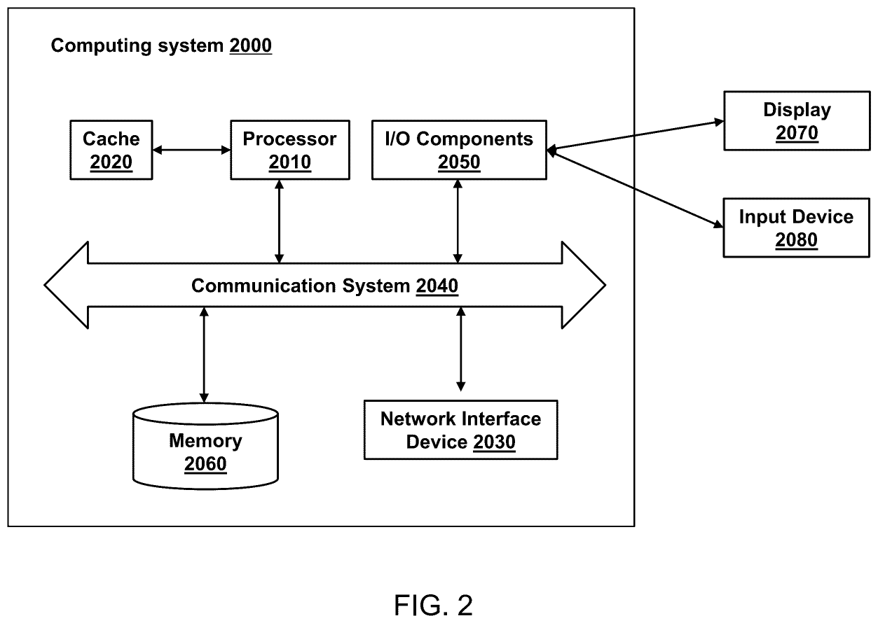

Referring to FIG. 1, illustrated is a diagram depicting an example communication environment 100 including communication systems (or communication apparatuses) 105, 108, according to one or more embodiments. In one embodiment, the communication system 105 includes a baseband circuitry 110 and a transmitter circuitry 120, and the communication system 108 includes a baseband circuitry 150 and a receiver circuitry 140. In one aspect, the communication system 105 is considered a transmitter communication system, and the communication system 108 is considered a receiver communication system. These components operate together to exchange data (e.g., messages or frames) through a wireless medium. These components are embodied as application specific integrated circuit (ASIC), field programmable gate array (FPGA), or any combination of these, in one or more embodiments. In some implementations, the communication systems 105, 108 include more, fewer, or different components than shown in FIG. 1. For example, each of the communication systems 105, 108 includes transceiver circuitry to allow bi-directional communication between the communication systems 105, 108 or with other communication systems. In some implementations, each of the communication systems 105, 108 may have configuration similar to that of a computing system 2000 as shown in FIG. 2.

The baseband circuitry 110 of the communication system 105 is a circuitry that generates the baseband data 115 for transmission. The baseband data 115 includes information data (e.g., signal(s)) at a baseband frequency for transmission. In one approach, the baseband circuitry 110 includes an encoder 130 that encodes the data and generates or outputs parity bits. In one aspect, the baseband circuitry 110 (or encoder 130) obtains a generator matrix or a parity check matrix or uses a previously produced generator matrix or a previously produced parity check matrix and encodes the information data by applying the information data to the generator matrix or the parity check matrix to obtain a codeword. In some implementations, the baseband circuitry 110 stores one or more generator matrices or one or more parity check matrices that conform to any IEEE 802.11 standard for WLAN communication. The baseband circuitry 110 retrieves the stored generator matrix or the stored parity check matrix in response to detecting information data to be transmitted, or in response to receiving an instruction to encode the information data. In one approach, the baseband circuitry 110 generates the parity bits according to a portion of the generator matrix or using the parity check matrix and appends the parity bits to the information bits to form a codeword. The baseband circuitry 110 generates the baseband data 115 including the codeword for the communication system 108 and provides the baseband data 115 to the transmitter circuitry 120.

The transmitter circuitry 120 of the communication system 105 includes or corresponds to a circuitry that receives the baseband data 115 from the baseband circuitry 110 and transmits a wireless signal 125 according to the baseband data 115. In one configuration, the transmitter circuitry 120 is coupled between the baseband circuitry 110 and an antenna (not shown). In this configuration, the transmitter circuitry 120 up-converts the baseband data 115 from the baseband circuitry 110 onto a carrier signal to generate the wireless signal 125 at a radio frequency (RF) frequency (e.g., 10 MHz to 60 GHz), and transmits the wireless signal 125 through the antenna.

The receiver circuitry 140 of the communication system 108 is a circuitry that receives the wireless signal 125 from the communication system 105 and obtains baseband data 145 from the received wireless signal 125. In one configuration, the receiver circuitry 140 is coupled between the baseband circuitry 150 and an antenna (not shown). In this configuration, the receiver circuitry 140 receives the wireless signal 125 though an antenna, and down-converts the wireless signal 125 at an RF frequency according to a carrier signal to obtain the baseband data 145 from the wireless signal 125. The receiver circuitry 140 then provides the baseband data 145 to the baseband circuitry 150.

The baseband circuitry 150 of the communication system 108 includes or corresponds to a circuitry that receives the baseband data 145 from the receiver circuitry 140 and obtains information data from the received baseband data 145. In one embodiment, the baseband circuitry 150 includes a decoder 160 that extracts information and parity bits from the baseband data 145. The decoder 160 decodes the baseband data 145 to obtain the information data generated by the baseband circuitry 110 of the communication system 105.

In some implementations, each of the baseband circuitry 110 (including the encoder 130), the transmitter circuitry 120, the receiver circuitry 140, and the baseband circuitry 150 (including the decoder 160) may be as one or more processors, application specific integrated circuit (ASIC), field programmable gate array (FPGA), or any combination of them.

FIG. 2 is a schematic block diagram of a computing system, according to an embodiment. An illustrated example computing system 2000 includes one or more processors 2010 in direct or indirect communication, via a communication system 2040 (e.g., bus), with memory 2060, at least one network interface controller 2030 with network interface port for connection to a network (not shown), and other components, e.g., input/output (“I/O”) components 2050. Generally, the processor(s) 2010 will execute instructions (or computer programs) received from memory. The processor(s) 2010 illustrated incorporate, or are connected to, cache memory 2020. In some instances, instructions are read from memory 2060 into cache memory 2020 and executed by the processor(s) 2010 from cache memory 2020. The computing system 2000 may not necessarily contain all of these components shown in FIG. 2 and may contain other components that are not shown in FIG. 2.

In more detail, the processor(s) 2010 may be any logic circuitry that processes instructions, e.g., instructions fetched from the memory 2060 or cache 2020. In many implementations, the processor(s) 2010 are microprocessor units or special purpose processors. The computing device 2050 may be based on any processor, or set of processors, capable of operating as described herein. The processor(s) 2010 may be single core or multi-core processor(s). The processor(s) 2010 may be multiple distinct processors.

The memory 2060 may be any device suitable for storing computer readable data. The memory 2060 may be a device with fixed storage or a device for reading removable storage media. Examples include all forms of volatile memory (e.g., RAM), non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 2000 may have any number of memory devices 2060.

The cache memory 2020 is generally a form of computer memory placed in close proximity to the processor(s) 2010 for fast read times. In some implementations, the cache memory 2020 is part of, or on the same chip as, the processor(s) 2010. In some implementations, there are multiple levels of cache 2020, e.g., L2 and L3 cache layers.

The network interface controller 2030 manages data exchanges via the network interface (sometimes referred to as network interface ports). The network interface controller 2030 handles the physical and data link layers of the OSI model for network communication. In some implementations, some of the network interface controller's tasks are handled by one or more of the processor(s) 2010. In some implementations, the network interface controller 2030 is part of a processor 2010. In some implementations, the computing system 2000 has multiple network interfaces controlled by a single controller 2030. In some implementations, the computing system 2000 has multiple network interface controllers 2030. In some implementations, each network interface is a connection point for a physical network link (e.g., a cat-5 Ethernet link). In some implementations, the network interface controller 2030 supports wireless network connections and an interface port is a wireless (e.g., radio) receiver or transmitter (e.g., for any of the IEEE 802.11 protocols, near field communication “NFC”, Bluetooth, ANT, or any other wireless protocol). In some implementations, the network interface controller 2030 implements one or more network protocols such as Ethernet. Generally, a computing device 2050 exchanges data with other computing devices via physical or wireless links through a network interface. The network interface may link directly to another device or to another device via an intermediary device, e.g., a network device such as a hub, a bridge, a switch, or a router, connecting the computing device 2000 to a data network such as the Internet.

The computing system 2000 may include, or provide interfaces for, one or more input or output (“I/O”) devices. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 2000 may include an interface (e.g., a universal serial bus (USB) interface) for connecting input devices, output devices, or additional memory devices (e.g., portable flash drive or external media drive). In some implementations, a computing device 2000 includes an additional device such as a co-processor, e.g., a math co-processor can assist the processor 2010 with high precision or complex calculations.

The components 2090 may be configured to connect with external media, a display 2070, an input device 2080 or any other components in the computing system 2000, or combinations thereof. The display 2070 may be a liquid crystal display (LCD), an organic light emitting diode (OLED) display, a flat panel display, a solid state display, a cathode ray tube (CRT) display, a projector, a printer or other now known or later developed display device for outputting determined information. The display 2070 may act as an interface for the user to see the functioning of the processor(s) 2010, or specifically as an interface with the software stored in the memory 2060.

The input device 2080 may be configured to allow a user to interact with any of the components of the computing system 2000. The input device 2080 may be a plurality pad, a keyboard, a cursor control device, such as a mouse, or a joystick. Also, the input device 2080 may be a remote control, touchscreen display (which may be a combination of the display 2070 and the input device 2080), or any other device operative to interact with the computing system 2000, such as any device operative to act as an interface between a user and the computing system 2000.

In one aspect, automatic gain control (AGC) is performed in many electronic circuits to regulate the signal strength of a received signal at the input of analog-to-digital converters (ADCs) to meet the required signal-to-noise ratio (SNR). When the signal strength of the received signal is weak (e.g., lower than a threshold) at an antenna, the AGC can increase the receiver gain to minimize noise and elevate the signal level to an acceptable SNR. Conversely, if the signal strength is strong (e.g., higher than a threshold), the AGC can decrease the receiver gain to prevent signal clipping, which can cause nonlinear degradation and deteriorate the SNR.

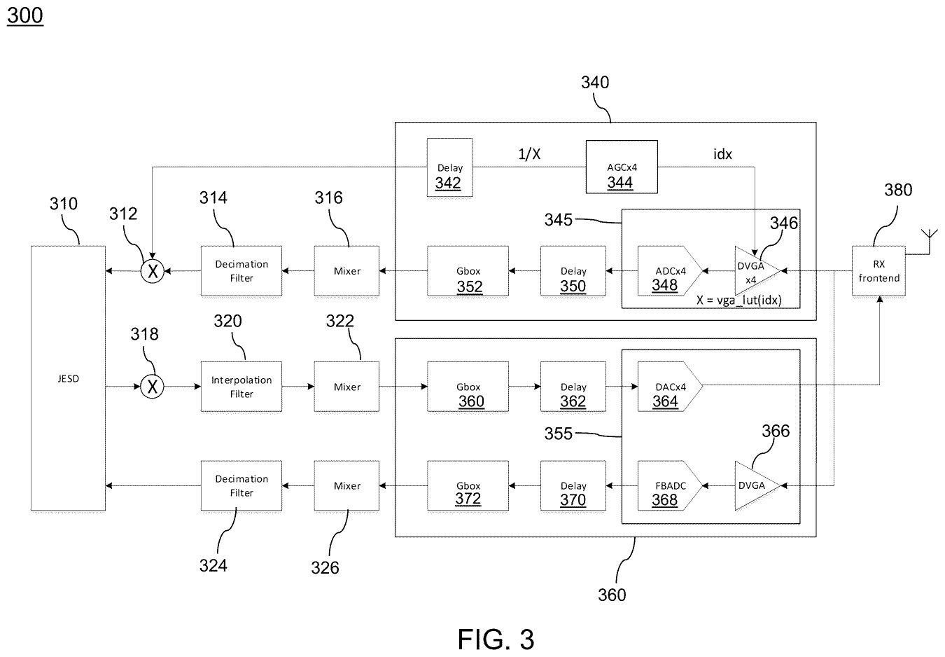

In one aspect, an AGC loop in a wireless communication system (e.g., communication system 105, 108) can manage various circuitry blocks controlling analog gain and attenuation at different stages in the receiving data path. FIG. 3 is a block diagram depicting an example data path in a subsystem 300 performing an AGC function in a wireless communication system (e.g., communication system 105, 108), according to one or more embodiments. Referring to FIG. 3, the subsystem 300 can include an RX line wrapper 340, a mixer 316, a decimation filter 314, a radio frequency (RF) digital signal processor (RFDSP) multiplier (e.g., gearbox multiplier) 312, a data converter interface (e.g., JESD 310), a multiplier 318, an interpolation filter 320, decimation filter 324, mixers 322, 326, and/or a transmit feedback (TXFB) line wrapper 360. The RX line wrapper 360 can include an analog RX circuit 345, delay circuits 342, 350, an AGC circuit 344, and/or gearbox 352. The analog RX circuit 345 can include a digital variable gain amplifier (DVGA) 346 and/or ADCs 348. The TXFB line wrapper 360 can include a TX analog circuit 355, delay circuits 362, 370, and/or gearboxes 360, 372. The TX analog circuit 355 can include a DVGA 366, digital-to-analog converters (DACs) 364 and/or a feedback ADC 368. An AGC loop for a signal received at a receive (RX) frontend 380 can monitor data samples from each ADC channel (e.g., each of 4 channels), provide gain control for DVGA components (e.g., the AGC 344 can send a gain index to DVGAs 346), and send appropriate gain correction values (e.g., value 1/X) to the gearbox multipliers (e.g., multiplier 32) to adjust the output of the gearbox (e.g., gearbox 352) in the RFDSP, as illustrated in FIG. 3.

In one aspect, in the AGC function, high and low thresholds can be used to define an acceptable range of signal strength of an ADC signal. If the ADC signal falls outside this range, a gain adjustment can be applied. Each time a gain change occurs, the updated gain can be applied to a DVGA (e.g., DVGA 346), and the corresponding gain correction can be applied to a gearbox multiplier (e.g., gearbox multiplier 312) after a certain delay (e.g., delay 350). Due to the inherent delay in an analog circuit, these adjustments may not align perfectly, potentially introducing small glitches during gain transitions.

To solve this problem, systems and methods according to some embodiments of the present disclosure can perform an enhanced automatic gain control (AGC) with a dynamic hysteresis algorithm. In some implementations, to mitigate unnecessary gain changes, a system (e.g., communication system 105, 108, the subsystem 300) can provide a hysteresis function or a hysteresis mode (e.g., a hysteresis circuit implementing the hysteresis function or the hysteresis function mode) for AGC operations. In some implementations, the system can enable the hysteresis circuit to monitor whether gain stabilization has been achieved during an AGC tracking mode, and reduce gain fluctuations once gain stabilization has been achieved.

In some implementations, when the hysteresis function is enabled, the system can enable or start a timer (e.g., a timer circuit) to track a period of ADC samples (e.g., the timer counts down until a predetermined period elapses). The system can determine whether a gain adjustment (either increase or decrease) occurs during this sample period. In response to determining that a gain adjustment occurs during this sample period, the system can reset the timer and start the timer to count down again. In response to determining that (1) all ADC values (e.g., signal strength values) remain within a range defined by a high threshold (adc_high_th or “first threshold”) and a low threshold (adc_low_th or “third threshold”), and (2) no gain adjustment occurs until the timer expires, the system can enter a “stable” state, indicating that the current gain situation is relatively stable. In some implementations, the system can set the timer to a value larger than the entire ADC sample window iteration to avoid under-sampling. In some implementations, the system can decrease or reduce a gain of an amplifier including resistors (e.g., an amplifier including an input resistor, a feedback resistor, biasing resistors, emitter resistors) by adjusting the resistors (e.g., increasing the input resistor and/or decreasing the feedback resistor, increasing an emitter resistor, etc.). In some implementations, the system can decrease or reduce a gain of an amplifier using software (e.g., using a user interface or remote control). In some implementations, the system can increase a gain of an amplifier including resistors (e.g., an amplifier including an input resistor, a feedback resistor, biasing resistors, emitter resistors) by adjusting the resistors (e.g., decreasing the input resistor and/or increasing the feedback resistor, decreasing an emitter resistor, etc.) or increasing a supply voltage. In some implementations, the system can increase a gain of an amplifier using software (e.g., using a user interface or remote control).

In some implementations, upon entering the stable state, the system can expand both the high threshold and the low threshold to a wider range. For example, the system can change the high threshold to a high hysteresis threshold (adc_high_hys_th or “high-high threshold” or “second threshold” which is greater than the high threshold) and the low threshold to a low hysteresis threshold (adc_low_hys_th or “low-low threshold” or “fourth threshold” which is less than the low threshold), thereby preventing further ADC fluctuations within this updated range from triggering gain changes. In some implementations, the system can set thresholds (e.g., high threshold, high hysteresis threshold, low threshold, low hysteresis) can be set based at least on an input signal level, a desired output level, a type of modulation (e.g., amplitude modulation, frequency modulation), system dynamics (e.g., tradeoff between quick responses to signal changes and avoiding excessive fluctuations), and/or detector characteristics (e.g., peak detector, average detector in an AGC system). The system can determine whether any ADC sample value falls outside this updated range. In response to determining that any ADC sample falls outside this updated range, the system can adjust the gain accordingly, the system can exits the stable state, and reset the thresholds (e.g., the high hysteresis threshold and/or the low hysteresis threshold) to their normal settings (e.g., the high threshold and/or the low threshold).

For example, the system can set a high threshold, a high hysteresis threshold, a low threshold, and a low hysteresis threshold such that the high threshold is greater than the low threshold, the high hysteresis threshold is greater than the high threshold, and the low hysteresis threshold is less than the low threshold. In some implementations, after the system enters a stable state (during the stable state), in response to determining that a signal strength of a signal is less than the high hysteresis threshold, the system does not make gain adjustment. Similarly, during the stable state, in response to determining that a signal strength of the signal is greater than the low hysteresis threshold during a decay time period (e.g., the whole decay time period set by a decay timer), the system does not make gain adjustment. During the stable state, in response to determining that a signal strength of the signal is greater than the high hysteresis threshold, the system can reduce the gain of an amplifier immediately based on the signal strength. On the other hand, during the stable state, in response to determining that a signal strength of the signal remains to be less than the low hysteresis threshold during a decay time period (e.g., the whole decay time period) set by the decay timer, the system can increase the gain of the amplifier based on the signal strength.

In some implementations, a subsystem of a wireless communication system (e.g., communication system 105, 108) can include one or more ADCs, one or more AGCs (e.g., AGC circuits), one or more VGAs (e.g., VGA circuits), one or more decimation filters, one or more RFDSP multipliers, and/or a data converter interface (e.g., JESD). An AGC circuit can include a conversion circuit (e.g., circuit for converting a signed value v to an absolute value |v|), a first-to-fourth comparators corresponding to a high threshold, a high hysteresis threshold, a low threshold, and a low hysteresis threshold (which may be stored in memory, registers, buffers, etc.), a gain index calculation circuit (e.g., adder), a multiplexer (or MUX), a delay circuit, a digital look-up table (LUT), and a VGA LUT. A VGA may include a VGA factor LUT.

In some implementations, an ADC can receive an amplified signal from a VGA, and provide a signal (e.g., a signed signal or 48 data samples or ADC samples) to the AGC. The ADC can also provide the signal to the decimation filter.

In some implementations, the AGC circuit can receive the signed signal, convert the signed signal to a signal with an absolute value using the conversion circuit. For example, the absolute value can be a 10 bit absolute value (e.g., by rounding a signed value −1024 to 1023). The AGC can determine a gain index corresponding to the converted signal using the hysteresis function and the thresholds (e.g., a high threshold, a high hysteresis threshold, a low threshold, and a low hysteresis threshold).

For example, the hysteresis function can implement a range extension logic as follows. The system can input the absolute value |v| of the converted signal, a high threshold, a high hysteresis threshold, a low threshold, and a low hysteresis threshold. In some implementations, each of the high threshold, the high hysteresis threshold, the low threshold, and the low hysteresis threshold can have a 10 bit absolute value. The system can then compare the absolute value |v| with a high threshold (using the first comparator), with a high hysteresis threshold (using the second comparator), with a low threshold (using the third comparator), and/or with a low hysteresis threshold (using the fourth comparator). When a timer (referred to as “high timer” or “high counter”) counts down during a predetermined time period (e.g., a time set by the high timer), in response to determining that the absolute value |v| is greater than the high threshold, the system can decrease the gain of the amplifier by updating the gain index (denoted by Idx) using the following equation:

$$Idx = idx - dec\_step \qquad ( Equation 1 )$$

where the dec_step is a predetermined index size for decrementing the gain.

When a timer (referred to as “low timer” or “low counter”) counts down during a predetermined time period (e.g., a time set by the low timer), in response to determining that the absolute value |v| remains to be less than the low threshold for a decay time period (e.g., the whole decay time period) set by a decay timer, the system can increase the gain of the amplifier by updating the gain index (denoted by Idx) using the following equation:

$$Idx = idx + inc\_step \qquad ( Equation 2 )$$

where the inc_step is a predetermined index size for incrementing the gain.

In some implementations, during a stable state, in response to determining that the absolute value |v| is greater than or equal to the high hysteresis threshold, the system can decrease the gain index (e.g., using Equation 1) and go to another state (e.g., idle state). Similarly, during a stable state, in response to determining that the absolute value |v| remains to be less than or equal to the low hysteresis threshold for a decay time period (e.g., the whole decay time period) set by the decay timer, the system can increase the gain index (e.g., using Equation 2) and go to another state (e.g., idle state). In some implementations, the gain index can be a 6 bit value.

In some implementations, the system can selectively output a determined gain index (e.g., 6 bit gain index) using the hysteresis function or a fixed gain index by selecting a tracking mode or a fixed mode using the MUX. The system can provide the output gain index to the delay circuit and to the VGA LUT. In some implementations, the VGA LUT can store a plurality of gain values (e.g., 8 bit gain values ranging from a minimum gain (or a maximum attenuation) to a maximum gain (or a minimum attenuation)) corresponding to a plurality of gain indexes (e.g., 56 gain indexes). In response to receiving the gain index output from the MUX, the system can identify or access a corresponding gain value (e.g., X) from the VGA LUT using the gain index output from the MUX, and provide the gain value to the VGA. The VGA factor LUT can store a plurality of VGA factors (e.g., VGA factors from −29.9 dB to 0.002 dB) corresponding to a plurality of gain indexes. In response to receiving the gain value, the VGA can identify or access a corresponding VGA factor from the VGA factor LUT, generate a signal based on the gain value and the corresponding VGA factor, and output the generated signal to the ADC.

In some implementations, in response to receiving the gain index output from the MUX, the delay circuit can generate a delay and provide the gain index to the digital LUT. The digital LUT can store a plurality of gain control values (e.g., 28 bit gain control values to fix a mismatch gain after performing a decimation filter) corresponding to a plurality of gain indexes (e.g., 64 gain indexes). In response to receiving the gain index output from the delay circuit, the system can identify or access a corresponding gain control value (e.g., 1/X) from the digital LUT using the gain index output from the delay circuit, and provide the gain control value to the RFDSP multiplier. The multiplier can multiply an output signal (e.g., with a gain X) from the decimation filter by the gain control value (e.g., 1/X) to fix the mismatch gain after the decimation filter, and provide a result of the multiplication to the JESD interface.

In some implementations, there can be two types or embodiments of gain adjustments in AGC. In a first embodiment (also referred to as “hysteresis mode-1”), the system can use a first (or “high”) state machine for a high threshold and a second (or “low”) state machine for a low threshold. The first state machine can include an idle state (“H-Idle” state) and a stable state (“H-Stable” state). Similarly, the second state machine can include an idle state (“L-Idle” state) and a stable state (“L-Stable” state). The first state machine and the second state machine can operate independently from each other. Each state machine can define transitions (or switches) between the states as described in the following sections. In some implementations, a state machine and its transitions (or switches) can be implemented in software (e.g., using a switch-case statement, a state transition table, and/or loop statement). In some implementations, a state machine and its transitions (or switches) can be implemented in hardware (e.g., using state registers, combinational logic to determine the next state based on the current state and inputs, combinational logic to generate outputs based on the current state).

In some implementations, for the first state machine, when a high timer starts to count down, the system can enter the H-Idle state. During the H-Idle state, when an ADC value is greater than a high threshold, the system can perform a transition T11 to reset (or restart) the high timer and remain in the H-Idle state. When the high timer expires (e.g., when the high timer counts down to zero), the system perform a transition T12 to the H-Stable state. While being in the H-Stable state, when an ADC value is greater than a high hysteresis threshold, the system can perform a transition T13 to the H-Idle state. While being in the H-Stable state, when an ADC value is less than or equal to the high hysteresis threshold (even if the ADC value is greater than the high threshold), the system can remain in the H-Stable state.

In some implementations, for the second state machine, when a low timer starts to count down, the system can enter the L-Idle state. During the L-Idle state, when all ADC values remain to be less than a low threshold for a decay time period (e.g., the whole decay time period) set by a decay timer, the system can perform a transition T15 to reset (or restart) the low timer and remain in the L-Idle state. The decay time period can be less than a time period set by the low timer. When the low timer expires (e.g., when the low timer counts down to zero), the system perform a transition T16 to the L-Stable state. While being in the L-Stable state, when all ADC values remain to be less than a low hysteresis threshold for a decay time period (e.g., the whole decay time period) set by the decay timer, the system can perform a transition T17 to the L-Idle state. While being in the L-Stable state, when an ADC value is greater than or equal to the low hysteresis threshold during the decay period (even if the ADC value is less than the low threshold), the system can remain in the L-Stable state.

In the first embodiment, the system can define a high threshold (“first threshold”), a high hysteresis threshold (“second threshold”) greater than the high threshold, a low threshold (“fifth threshold”) that is lower than the high threshold, and a low hysteresis threshold (“sixth threshold”) that is lower than the low threshold. In the first embodiment (or in the hysteresis mode-1), threshold switching in the system can operate independently for both the high threshold and the low threshold. Specifically, the thresholds can transition between the high hysteresis threshold and the high threshold, or between the low hysteresis threshold and the low threshold, independently. While the system (e.g., AGC subsystem) is in the H-Stable state, in response to determining that any ADC value exceeds the high hysteresis threshold, a high trigger (e.g., gain decrease event) can occurs. In response to the high trigger, the system can reduce the gain of an amplifier, and transition to the H-Idle state by resetting the threshold to the high threshold (from the high hysteresis threshold) and starting a high timer (e.g., a high counter). In response to determining that no high trigger is detected while the system is in the H-Idle state (before the high timer expires), when the high timer expires, the system can set the threshold back to the high hysteresis threshold, and transition to the H-Stable state. While the system is in the H-Idle state, in response to determining that any ADC value exceeds the high threshold, a high trigger (e.g., gain decrease event) can occurs. In response to the high trigger, the system can reduce the gain of the amplifier, restart the high timer and remain in the H-Idle state.

In some implementations, while the system (e.g., AGC subsystem) is in the L-Stable state, in response to determining that all ADC values remain to be less than the low hysteresis threshold for a decay time period (set by the decay timer), a low trigger (e.g., gain increase event) can occurs. In response to the low trigger, the system can increase the gain of the amplifier, and transition to the L-Idle state by resetting the threshold to the low threshold (from the low hysteresis threshold) and starting a low timer (e.g., low counter). In response to determining that no low trigger is detected for a decay time period while the system is in the L-Idle state (before the low timer expires), when the low timer expires, the system can set the threshold back to the low hysteresis threshold, and transition to the L-Stable state. While the system is in the L-Idle state, in response to determining that all ADC values remain to be less than the low threshold for a decay time period (set by the decay timer), a low trigger (e.g., gain increase event) can occurs. In response to the low trigger, the system can increase the gain of the amplifier, restart the low timer and remain in the L-Idle state.

In some implementations, each threshold (e.g., the high threshold, the high hysteresis threshold, the low threshold, the low hysteresis threshold) and each timer (e.g., high timer, low timer) can be configured independently.

In a second embodiment of gain adjustments in AGC (also referred to as “hysteresis mode-2”), the system can use a state machine including two states—an idle state and a stable state. When a timer starts to count down, the system can enter the idle state. During the idle state, when an ADC value is greater than a high threshold, the system can perform a transition T21 to reset (or restart) the timer and remain in the idle state. Similarly, during the idle state, when all ADC values remain to be less than a low threshold for a decay time period (e.g., the whole decay time period) set by a decay timer, the system can perform the transition T21 to reset (or restart) the timer and remain in the idle state. When the timer expires (e.g., when the timer counts down to zero), the system perform a transition T22 to the stable state. While being in the stable state, when an ADC value is greater than a high hysteresis threshold, the system can perform a transition T23 to the idle state. Similarly, while being in the stable state, when all ADC values remain to be less than a low hysteresis threshold for a decay time period (e.g., the whole decay time period) set by the decay timer, the system can perform the transition T23 to the idle state. While being in the stable state, when an ADC value is less than or equal to the high hysteresis threshold (even if the ADC value is greater than the high threshold), the system can remain in the stable state. Similarly, while being in the stable state, when an ADC value is greater than or equal to the low hysteresis threshold during a decay time period set by the decay timer (even if the ADC value is less than the low threshold), the system can remain in the stable state.

In the second embodiment, the system can define a high threshold (“first threshold”), a high hysteresis threshold (“second threshold”) greater than the high threshold, a low threshold (“third threshold”) that is lower than the high threshold, and a low hysteresis threshold (“fourth threshold”) that is lower than the low threshold. In some implementations, while the system (e.g., AGC subsystem) is in the stable state, in response to determining that a ADC value is greater than the high hysteresis threshold, a high trigger (e.g., gain decrease event) can occurs. In response to the high trigger, the system can decrease or reduce the gain of an amplifier, and transition to the idle state by resetting the threshold to the high threshold (from the high hysteresis threshold) and starting a timer. On the other hand, while the system is in the stable state, in response to determining that all ADC values remain to be less than the low hysteresis threshold for a decay time period (set by the decay timer), a low trigger (e.g., gain increase event) can occurs. In response to the low trigger, the system can increase the gain of the amplifier, and transition to the idle state by resetting the threshold to the low threshold (from the low hysteresis threshold) and starting the timer.

In the second embodiments, in response to determining that no high trigger is detected while the system is in the idle state (before the timer expires), when the timer expires, the system can set the threshold back to the high hysteresis threshold, and transition to the stable state. While the system is in the idle state, in response to determining that a value is greater than the high threshold, a high trigger (e.g., gain decrease event) can occurs. In response to the high trigger, the system can reduce or decrease the gain of the amplifier, restart the timer and remain in the idle state. On the other hand, in response to determining that no low trigger is detected for a decay time period while the system is in the idle state (before the timer expires), when the timer expires, the system can set the threshold back to the low hysteresis threshold, and transition to the stable state. While the system is in the idle state, in response to determining that all ADC values remain to be less than the low threshold for a decay time period (set by the decay timer), a low trigger (e.g., gain increase event) can occurs. In response to the low trigger, the system can increase the gain of the amplifier, restart the timer and remain in the idle state.

In the second embodiment, the system can use the same timer set to a predetermined time for both the high threshold and the low threshold. When a gain decrease event (e.g., the ADC value is greater than or equal to the high hysteresis threshold) occurs, the system can perform the transition T23 from the stable state to the idle state and start the timer set to the predetermined time. When, during the predetermined time, (1) all ADC values are between the high threshold and the low threshold and (2) there is no gain adjustment event (e.g., either a gain increase event or a gain decrease event), then the system can perform the transition T22 from the idle state to the stable state. When a gain increase event (e.g., the ADC value is less than or equal to the low hysteresis threshold), the system can perform the transition T23 from the stable state to the idle state and start the timer set to the predetermined time. When, during the predetermined time, (1) all ADC values are between the high threshold and the low threshold and (2) there is no gain adjustment event (e.g., either a gain increase event or a gain decrease event), then the system can perform the transition T22 from the idle state back to the stable state.

In the second embodiment (e.g., in the hysteresis mode-2), unlike in the hysteresis mode-1, both the high threshold and the low threshold can simultaneously switch from the high hysteresis threshold and the low hysteresis threshold, respectively. If either a high trigger (e.g., a gain decrease event) or a low trigger (e.g., a gain increase event) occurs, both the high hysteresis threshold and the low hysteresis threshold can revert to the high threshold and the low threshold, respectively, and the timer can be initiated.

In one aspect, a system (e.g., AGC subsystem) can suffer from clock coupling spurs induced by a supply ripple and/or a ground ripple of a constant AGC clock. The system may receive a gain index value (e.g., a 8 bit binary value) and adjust the gain of a programmable gain amplifier (PGA) based on the gain index value according to an AGC clock. In some cases, the gain index value and the AGC clock may be provided to a retiming logic through a long route from a digital/analog interface. The retiming logic may induce a supply ripple and/or a ground ripple. When the retiming logic provides a retimed gain index to the PGA, the PGA may generate an amplified signal of an RX input signal. Due to the supply ripple and/or the ground ripple, the PGA may generate clock spurs which may significantly degrade the receiver spurious-free dynamic range (SFDR) performance. For example, running AGC update may impact receiver performance due to continuous AGC clock coupling induced by the retiming logic supply ripple and/or ground ripple.

To address this problem, in some implementations, the system can provide an enhanced gated AGC clock that can remove such a coupling, thereby improving receiver spur performance during the AGC update. In some implementations, the system can enable the AGC clock only during AGC update using an AGC clock enable signal. The AGC clock enable signal can be used to gate and select the updating moment when the AGC gain index (or gain code) is changed. This enhancement can avoid the aforementioned spurs by removing the coupling to the receiver signal.

Embodiments in the present disclosure have at least the following advantages and benefits. First, embodiments in the present disclosure can provide hysteresis modes for reducing the number of gain transitions (or updates on PGA (or DVGA)) and reducing small glitches introduced during gain transitions. For example, when the hysteresis mode is disabled, signal changes under a Rayleigh fading channel cause the AGC control to update the PGA (DVGA) 80% more frequently than when any hysteresis mode is enabled.

Second, embodiments in the present disclosure can provide useful techniques for two hysteresis methods: hysteresis mode-1 and hysteresis mode-1. The hardware implementation of the hysteresis mode-1 results in fewer PGA updates compared to other methods. However, the hysteresis mode-1 implementation may include more complex hardware than the hysteresis mode-2. Although the hardware implementation of hysteresis mode-2 shows approximately a 3% higher PGA update rate than hysteresis mode-1, its simplicity can be advantageous for high-speed RF implementations, such as 16 GHz operation.

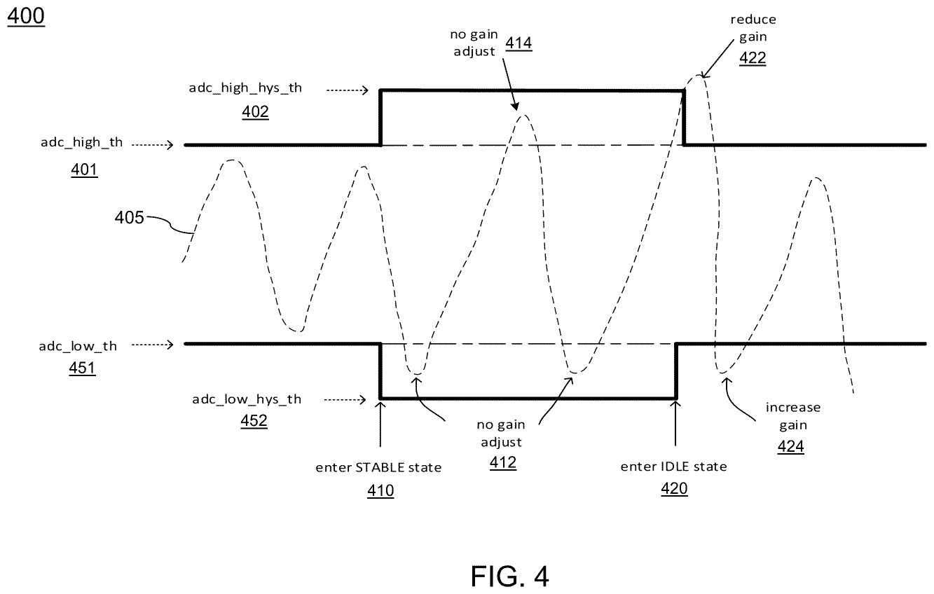

Referring to FIGS. 4-14, embodiments of systems and methods for the present solution to provide unequal encoding and modulation are described and illustrated.

FIG. 4 is a diagram 400 depicting example ADC operations using a hysteresis function according to one or more embodiments. Referring to FIG. 4, a system can set a high threshold 401, a high hysteresis threshold 402, a low threshold 451, and a low hysteresis threshold 452 such that the high threshold 401 is greater than the low threshold 451, the high hysteresis threshold 402 is greater than the high threshold 401, and the low hysteresis threshold 452 is less than the low threshold 451. After the system enters a stable state (during the stable state) 410, in response to determining that a signal strength of a signal 405 is less than the high hysteresis threshold, the system does not make gain adjustment 414. Similarly, during the stable state, in response to determining that a signal strength of the signal 405 is greater than the low hysteresis threshold 452, the system does not make gain adjustment 412. During the stable state, in response to determining that a signal strength of the signal 405 is greater than the high hysteresis threshold, the system can reduce the gain of an amplifier 422 based on the signal strength, enter an “idle” state, and start a timer. During the idle state, in response to determining that a signal strength of the signal 405 is less than the low hysteresis threshold, the system can increase the gain of the amplifier based on the signal strength 424, and restart the timer.

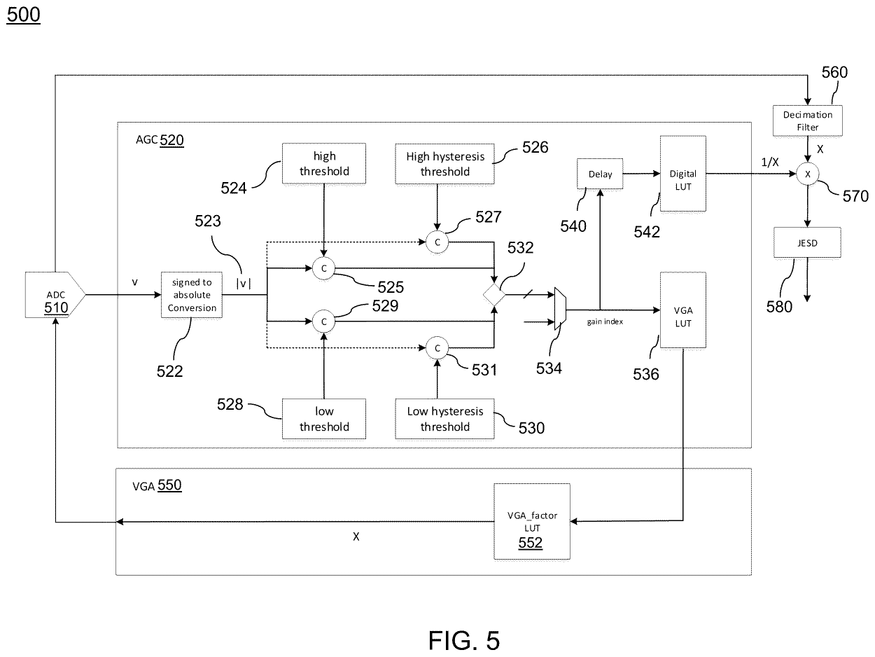

FIG. 5 is a block diagram depicting an example data path in a subsystem 500 performing an AGC function in a wireless communication system, according to one or more embodiments. The subsystem 500 of a wireless communication system (e.g., communication system 105, 108) can include one or more ADCs 510, one or more AGCs 520 (e.g., AGC circuits), one or more VGAs 550 (e.g., VGA circuits), one or more decimation filters 560, one or more RFDSP multipliers 570, and/or a data converter interface (e.g., JESD 580). An AGC circuit 520 can include a conversion circuit 522 (e.g., circuit for converting a signed value v to an absolute value |v|), a first-to-fourth comparators 525, 527, 529, 531 corresponding to a high threshold 524, a high hysteresis threshold 526, a low threshold 528, and a low hysteresis threshold 530 (which may be stored in memory, registers, buffers, etc.), a gain index calculation circuit 532 (e.g., adder), a multiplexer 534 (or MUX), a delay circuit 540, a digital look-up table (LUT) 542, and a VGA LUT 536. A VGA 550 may include a VGA factor LUT 552.

In some implementations, an ADC 510 can receive an amplified signal from a VGA 550, and provide a signal v (e.g., a signed signal or 48 data samples or ADC samples) to the AGC 520. The ADC 510 can also provide the signal to the decimation filter 560.

In some implementations, the AGC circuit 520 can receive the signed signal v, convert the signed signal v to a signal with an absolute value |v| (523) using the conversion circuit 522. For example, the absolute value can be a 10 bit absolute value (e.g., by rounding a signed value −1024 to 1023). The AGC 520 can determine a gain index corresponding to the converted signal |v| using the hysteresis function and the thresholds (e.g., a high threshold 524, a high hysteresis threshold 526, a low threshold 528, and a low hysteresis threshold 530).

For example, the hysteresis function can implement a range extension logic as follows. The system can input the absolute value |v| of the converted signal, a high threshold, a high hysteresis threshold, a low threshold, and a low hysteresis threshold. In some implementations, each of the high threshold, the high hysteresis threshold, the low threshold, and the low hysteresis threshold can have a 10 bit absolute value. The system can then compare the absolute value |v| with a high threshold 524 (using the first comparator 525), with a high hysteresis threshold 526 (using the second comparator 527), with a low threshold 528 (using the third comparator 529), and/or with a low hysteresis threshold 530 (using the fourth comparator 531).

When a high timer (e.g., high timer 655) counts down during a predetermined time period (e.g., a time set by the high timer), in response to determining that the absolute value |v| is greater than the high threshold 524, the system can decrease the gain of the amplifier by updating the gain index (denoted by Idx) using Equation 1. When a low timer (e.g., low timer 675) counts down during a predetermined time period (e.g., a time set by the low timer), in response to determining that the absolute value |v| remains to be less than the low threshold 528 for a decay time period (e.g., the whole decay time period) set by a decay timer (e.g., decay timer 635), the system can increase the gain of the amplifier by updating the gain index (denoted by Idx) using Equation 2.

During a stable state, in response to determining that the absolute value |v| is greater than or equal to the high hysteresis threshold 526, the system can decrease the gain index (e.g., using Equation 1) and go to another state (e.g., idle state). Similarly, during a stable state, in response to determining that the absolute value |v| remains to be less than or equal to the low hysteresis threshold 530 for a decay time period (e.g., the whole decay time period) set by the decay timer, the system can increase the gain index (e.g., using Equation 2) and go to another state (e.g., idle state). In some implementations, the gain index can be a 6 bit value.

The system can selectively output a determined gain index (e.g., 6 bit gain index) using the hysteresis function or a fixed gain index by selecting a tracking mode or a fixed mode using the MUX 534. The system can provide the output gain index to the delay circuit 540 and to the VGA LUT 536. The VGA LUT 536 can store a plurality of gain values (e.g., 8 bit gain values ranging from a minimum gain (or a maximum attenuation) to a maximum gain (or a minimum attenuation)) corresponding to a plurality of gain indexes (e.g., 56 gain indexes). In response to receiving the gain index output from the MUX 534, the system can identify or access a corresponding gain value (e.g., X) from the VGA LUT 536 using the gain index output from the MUX 534, and provide the gain value to the VGA 550. The VGA factor LUT 552 can store a plurality of VGA factors (e.g., VGA factors from −29.9 dB to 0.002 dB) corresponding to a plurality of gain indexes. In response to receiving the gain value, the VGA 550 can identify or access a corresponding VGA factor from the VGA factor LUT, generate a signal based on the gain value and the corresponding VGA factor, and output the generated signal to the ADC 510.

In response to receiving the gain index output from the MUX 534, the delay circuit 540 can generate a delay and provide the gain index to the digital LUT 542. The digital LUT 542 can store a plurality of gain control values (e.g., 28 bit gain control values to fix a mismatch gain after performing a decimation filter) corresponding to a plurality of gain indexes (e.g., 64 gain indexes). In response to receiving the gain index output from the delay circuit 540, the system can identify or access a corresponding gain control value (e.g., 1/X) from the digital LUT 542 using the gain index output from the delay circuit 540, and provide the gain control value to the RFDSP multiplier 570. The multiplier 570 can multiply an output signal (e.g., with a gain X) from the decimation filter 560 by the gain control value (e.g., 1/X) to fix the mismatch gain after the decimation filter 560, and provide a result of the multiplication to the JESD interface 580.

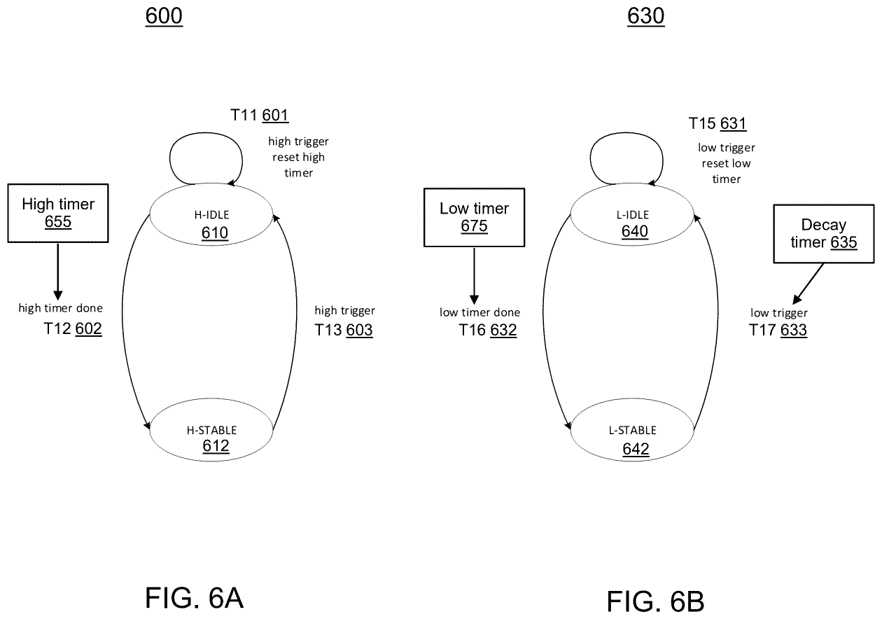

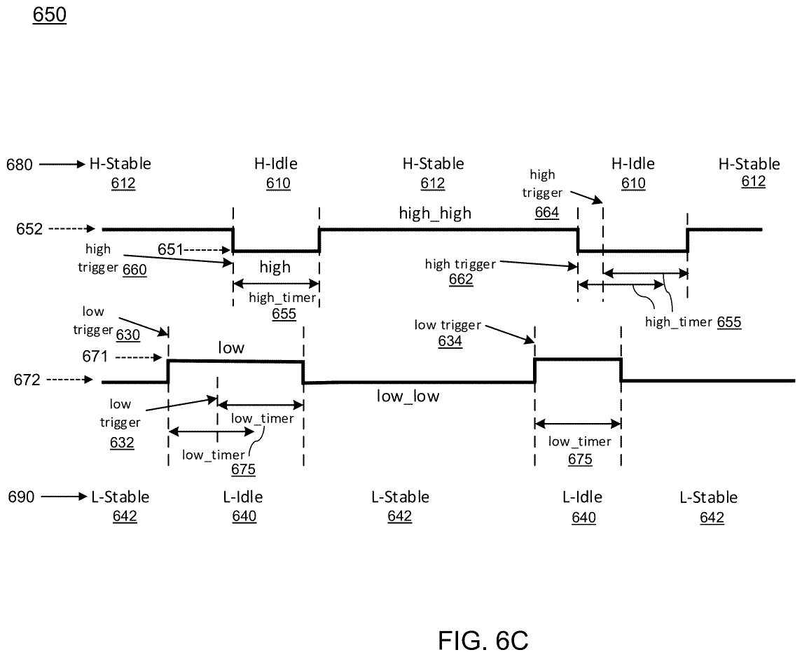

FIG. 6A to FIG. 6C are diagrams depicting an example of state machines 600, 630 and a hysteresis function (“the hysteresis mode-1”) for performing ADC operations 650 according to one or more embodiments. Referring to FIG. 6A, in the hysteresis mode-1, the system (e.g., subsystem 300, AGC circuit 520) can use a first (or “high”) state machine 600 for a high threshold and a second (or “low”) state machine 650 for a low threshold. The first state machine 600 can include an idle state (“H-Idle” state 610) and a stable state (“H-Stable” state 612). Similarly, the second state machine 630 can include an idle state (“L-Idle” state 640) and a stable state (“L-Stable” state 642). The first state machine 600 and the second state machine 630 can operate independently from each other. Each state machine can define transitions between the states as described in the following sections.

Referring to FIG. 6A, for the first state machine 600, when a high timer 655 starts to count down, the system can enter the H-Idle state 610. During the H-Idle state 610, when an ADC value (e.g., voltage value |v| 523) is greater than a high threshold (e.g., threshold 524), the system can perform a transition T11 (601) to reset (or restart) the high timer 655 and remain in the H-Idle state 610. When the high timer 655 expires (e.g., when the high timer 655 counts down to zero), the system perform a transition T12 (602) to the H-Stable state 612. While being in the H-Stable state 612, when an ADC value is greater than a high hysteresis threshold (e.g., threshold 526), the system can perform a transition T13 (603) to the H-Idle state 610. While being in the H-Stable state 610, when an ADC value is less than or equal to the high hysteresis threshold (even if the ADC value is greater than the high threshold), the system can remain in the H-Stable state 612.

Referring to FIG. 6B, for the second state machine 630, when a low timer 675 starts to count down, the system can enter the L-Idle state 640. During the L-Idle state 640, when all ADC values remain to be less than a low threshold (e.g., threshold 528) for a decay time period (e.g., the whole decay time period) set by a decay timer 635, the system can perform a transition T15 (631) to reset (or restart) the low timer 675 and remain in the L-Idle state 640. The decay time period can be less than a time period set by the low timer 675. When the low timer 675 expires (e.g., when the low timer 675 counts down to zero), the system perform a transition T16 (632) to the L-Stable state 642. While being in the L-Stable state 642, when all ADC values remain to be less than a low hysteresis threshold (e.g., threshold 530) for a decay time period (e.g., the whole decay time period) set by the decay timer 635, the system can perform a transition T17 (633) to the L-Idle state 640. While being in the L-Stable state 642, when an ADC value is greater than or equal to the low hysteresis threshold during the decay period (even if the ADC value is less than the low threshold), the system can remain in the L-Stable state 642.

Referring to FIG. 6C, in the hysteresis mode-1, the system can define a high threshold 651 (“first threshold”), a high hysteresis threshold 652 (“second threshold”) greater than the high threshold 651, a low threshold 671 (“fifth threshold”) that is lower than the high threshold 651, and a low hysteresis threshold 672 (“sixth threshold”) that is lower than the low threshold 671. In the hysteresis mode-1, threshold switching in the system can operate independently for both the high threshold 651 and the low threshold 671. Specifically, the thresholds can transition between the high hysteresis threshold 652 and the high threshold 651, or between the low hysteresis threshold 672 and the low threshold 671, independently. FIG. 6C also shows state transitions 680, 690. While the system (e.g., subsystem 300, AGC circuit 520) is in the H-Stable state 612, in response to determining that any ADC value exceeds the high hysteresis threshold 652, a high trigger 660, 662 (e.g., gain decrease event) can occurs. In response to the high trigger 660, 662, the system can reduce the gain of an amplifier (e.g., DVGA 346, VGA 550), and transition to the H-Idle state 610 by resetting the threshold to the high threshold 651 (from the high hysteresis threshold 652) and starting a high timer 655. In response to determining that no high trigger is detected while the system is in the H-Idle state (before the high timer 655 expires), when the high timer 655 expires, the system can set the threshold back to the high hysteresis threshold 652, and transition to the H-Stable state 612. While the system is in the H-Idle state 610, in response to determining that any ADC value exceeds the high threshold 651, a high trigger 664 (e.g., gain decrease event) can occurs. In response to the high trigger 664, the system can reduce the gain of the amplifier, restart the high timer 655 and remain in the H-Idle state 610.

Referring to FIG. 6C, while the system is in the L-Stable state 642, in response to determining that all ADC values remain to be less than the low hysteresis threshold 671 for a decay time period (set by the decay timer 635), a low trigger 630, 634 (e.g., gain increase event) can occurs. In response to the low trigger 630, 634, the system can increase the gain of the amplifier, and transition to the L-Idle state 640 by resetting the threshold to the low threshold 671 (from the low hysteresis threshold 672) and starting a low timer 675. In response to determining that no low trigger is detected for a decay time period while the system is in the L-Idle state 640 (before the low timer 675 expires), when the low timer 675 expires, the system can set the threshold back to the low hysteresis threshold 671, and transition to the L-Stable state 642. While the system is in the L-Idle state 640, in response to determining that all ADC values remain to be less than the low threshold for a decay time period (set by the decay timer 635), a low trigger 632 (e.g., gain increase event) can occurs. In response to the low trigger 632, the system can increase the gain of the amplifier, restart the low timer 675 and remain in the L-Idle state 640.

In some implementations, each threshold (e.g., the high threshold 651, the high hysteresis threshold 652, the low threshold 671, the low hysteresis threshold 672) and each timer (e.g., high timer 655, low timer 675) can be configured independently.

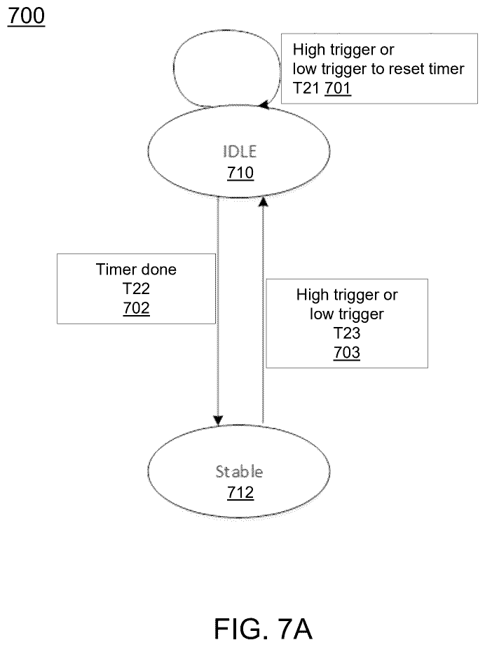

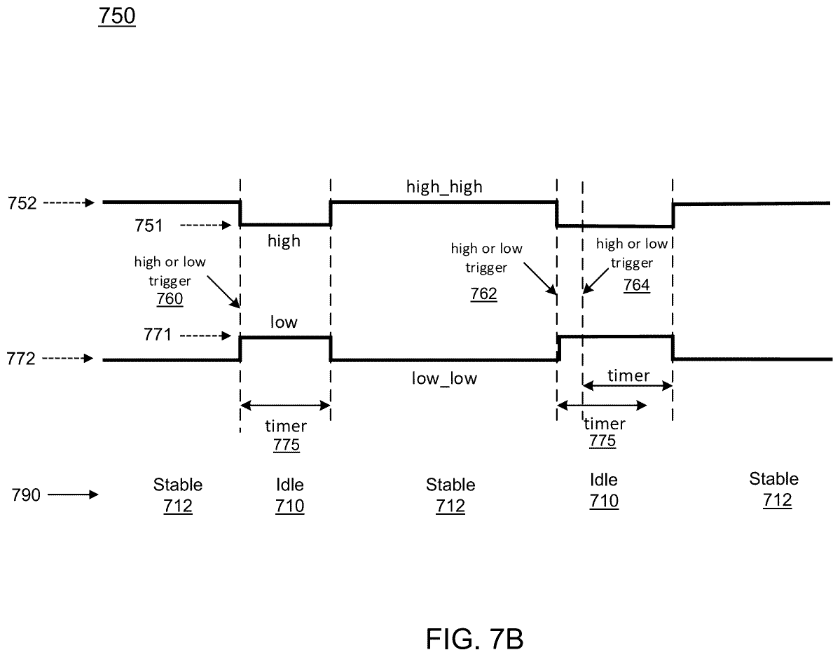

FIGS. 7A and 7B are diagrams depicting another example of a state machine 700 and a hysteresis function for performing ADC operations 750 in the hysteresis mode-2, according to one or more embodiments. Referring to FIG. 7A, in the hysteresis mode-2, the system (e.g., subsystem 300, AGC circuit 520) can use a state machine 700 including two states—an idle state 710 and a stable state 712. When a timer 775 (see FIG. 7B) starts to count down, the system can enter the idle state 710. During the idle state 710, when an ADC value (e.g., voltage value |v| 523) is greater than a high threshold (e.g., threshold 524), the system can perform a transition T21 (701) to reset (or restart) the timer 775 and remain in the idle state 710. Similarly, during the idle state 710, when all ADC values remain to be less than a low threshold (e.g., threshold 528) for a decay time period (e.g., the whole decay time period) set by a decay timer (not shown), the system can perform the transition T21 (701) to reset (or restart) the timer 775 and remain in the idle state 710. When the timer 775 expires (e.g., when the timer 775 counts down to zero), the system perform a transition T22 (702) to the stable state 712. While being in the stable state 712, when an ADC value is greater than a high hysteresis threshold (e.g., threshold 526), the system can perform a transition T23 (703) to the idle state 710. Similarly, while being in the stable state 712, when all ADC values remain to be less than a low hysteresis threshold (e.g., threshold 530) for a decay time period (e.g., the whole decay time period) set by the decay timer, the system can perform the transition T23 (703) to the idle state 710. While being in the stable state 712, when an ADC value is less than or equal to the high hysteresis threshold (even if the ADC value is greater than the high threshold), the system can remain in the stable state 712. Similarly, while being in the stable state 712, when an ADC value is greater than or equal to the low hysteresis threshold during a decay time period set by the decay timer (even if the ADC value is less than the low threshold), the system can remain in the stable state 712.

Referring to FIG. 7B, the system can define a high threshold 751 (“first threshold”), a high hysteresis threshold 752 (“second threshold”) greater than the high threshold 751, a low threshold 771 (“third threshold”) that is lower than the high threshold 751, and a low hysteresis threshold 772 (“fourth threshold”) that is lower than the low threshold 751. FIG. 7B also shows state transitions 790. While the system is in the stable state 712, in response to determining that a ADC value is greater than the high hysteresis threshold 752, a high trigger 760, 762 (e.g., gain decrease event) can occurs. In response to the high trigger 760, 762, the system can decrease or reduce the gain of an amplifier (e.g., DVGA 346, VGA 550), and transition to the idle state 710 by resetting the threshold to the high threshold 751 (from the high hysteresis threshold 752) and starting a timer 775. On the other hand, while the system is in the stable state 712 in response to determining that all ADC values remain to be less than the low hysteresis threshold 772 for a decay time period (set by the decay timer), a low trigger 760, 762 (e.g., gain increase event) can occurs. In response to the low trigger 760, 762, the system can increase the gain of the amplifier, and transition to the idle state 710 by resetting the threshold to the low threshold 771 (from the low hysteresis threshold 772) and starting the timer 775.

Referring to FIG. 7B, in response to determining that no high trigger is detected while the system is in the idle state 710 (before the timer 775 expires), when the timer 775 expires, the system can set the threshold back to the high hysteresis threshold 752, and transition to the stable state 712. While the system is in the idle state 710, in response to determining that a value is greater than the high threshold 751, a high trigger 760, 762 (e.g., gain decrease event) can occurs. In response to the high trigger 760, 762, the system can reduce or decrease the gain of the amplifier, restart the timer 775 and remain in the idle state 710. On the other hand, in response to determining that no low trigger is detected for a decay time period while the system is in the idle state 710 (before the timer 775 expires), when the timer 775 expires, the system can set the threshold back to the low hysteresis threshold 772, and transition to the stable state 712. While the system is in the idle state 710, in response to determining that all ADC values remain to be less than the low threshold for a decay time period (set by the decay timer), a low trigger 764 (e.g., gain increase event) can occurs. In response to the low trigger 764, the system can increase the gain of the amplifier, restart the timer 775 and remain in the idle state 710.

In the hysteresis mode-2, the system can use the same timer 775 set to a predetermined time for both the high threshold 751 and the low threshold 771. When a gain decrease event (e.g., the ADC value is greater than or equal to the high hysteresis threshold 752) occurs, the system can perform the transition T23 (703) from the stable state 712 to the idle state 710 and start the timer 775 set to the predetermined time. When, during the predetermined time, (1) all ADC values are between the high threshold 751 and the low threshold 771 and (2) there is no gain adjustment event (e.g., either a gain increase event or a gain decrease event), then the system can perform the transition T22 (702) from the idle state 710 to the stable state 712. When a gain increase event (e.g., the ADC value is less than or equal to the low hysteresis threshold 772), the system can perform the transition T23 (703) from the stable state 712 to the idle state 710 and start the timer 775 set to the predetermined time. When, during the predetermined time, (1) all ADC values are between the high threshold 751 and the low threshold 771 and (2) there is no gain adjustment event (e.g., either a gain increase event or a gain decrease event), then the system can perform the transition T22 (702) from the idle state 710 back to the stable state 712.

In the hysteresis mode-2, unlike in the hysteresis mode-1, both the high threshold 751 and the low threshold 771 can simultaneously switch from the high hysteresis threshold 752 and the low hysteresis threshold 772, respectively. If either a high trigger (e.g., a gain decrease event) or a low trigger (e.g., a gain increase event) occurs, both the high hysteresis threshold 752 and the low hysteresis threshold 772 can revert to the high threshold 751 and the low threshold 771, respectively, and the timer 775 can be initiated.

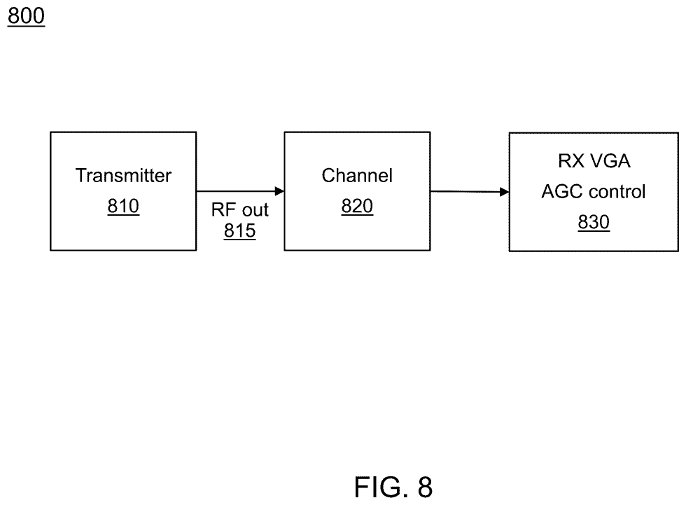

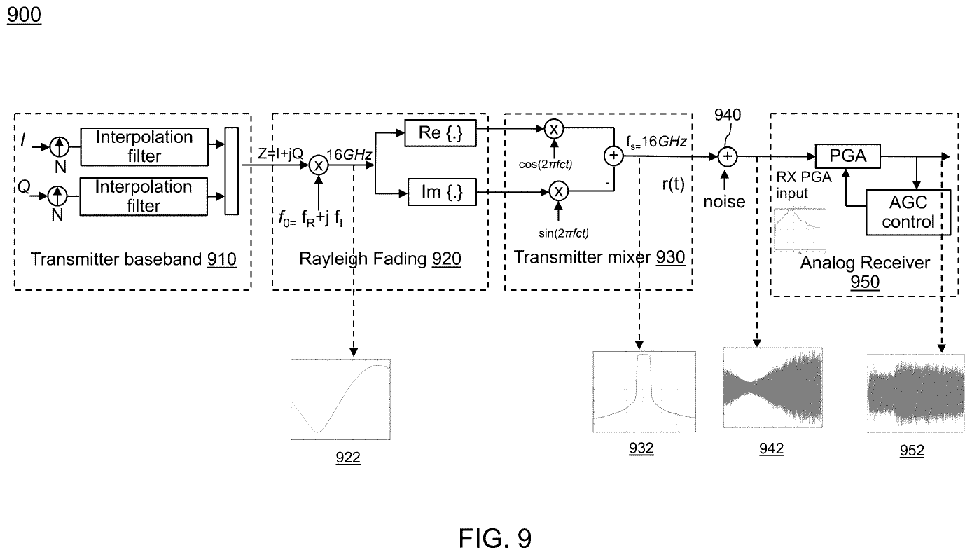

Now, simulations of the AGC Hysteresis modes and results will be described below with reference to FIG. 8 to FIG. 10. FIG. 8 is a block diagram depicting an example simulation system 800 for simulating AGC operations in a receive (RX) side (RX AGC operations) in a mobile environment, according to one or more embodiments. The simulation system includes a transmitter (simulator) 810, a channel (simulator) 820, and RX VGA AGC control (simulator) 830. AGC system level simulations were conducted by creating a mobile flat fading channel to simulate the update rate of AGC in each of these modes: (1) no hysteresis, (2) hysteresis mode-1, and (3) hysteresis mode-2. In the simulation setup, the characteristics of a wireless signal change as the wireless signal travels from a transmitter antenna to a receiver antenna. Objects located along the path of the wireless signal reflect the signal, and these reflected waves are received by the receiver. The channel, as depicted in the FIG. 9, represents a scattered wireless environment where multiple attenuated and delayed copies of the transmitted signal can arrive at the receiver via various paths. Depending on their phases, these multiple signals can either increase or decrease the received power at the receiver. The channel simulator in FIG. 8 is configured to quantify the performance of the receiver AGC hysteresis modes.

FIG. 9 is a diagram depicting an example simulation configuration for simulating RX AGC operations, according to one or more embodiments. The simulation configuration includes configurations of transmitter baseband 910, Rayleigh fading 920, transmitter mixer 930, and analog receiver 950. Referring to FIG. 9, the fading f_{O}(t) in the Rayleigh fading channel 920 is applied on the complex baseband signal z(t) generated from the transmitter baseband 910 to represent the fading at the RF (which is depicted in the diagram 922). Rayleigh fading is applied on the unmodulated signal before it is mixed with carrier frequency to represent the fading at RF signal. In the transmitter baseband 910, baseband I and Q signals are up-sampled by N times (e.g., by inserting N−1 zeros between each I and Q samples) and applied to interpolation filters. The complex valued Rayleigh fading signal with Doppler frequency is applied on the complex equivalent of the baseband signal z(t) (z=I+jQ). Then, this complex baseband equivalent of the faded signal is applied to the transmitter mixer 930 at carrier frequency fc to represent the faded transmitted signal at radio frequency (RF) f_{S}. The RF signal (which is depicted in the diagram 932) is then added 940 with a receiver noise. The noise-added signal (which is depicted in the diagram 942) is then applied to the input of the receiver PGA which is controlled by the AGC algorithm in the analog receiver 950. The signal output from the PGA as a result of the AGC algorithm is depicted in the diagram 952.

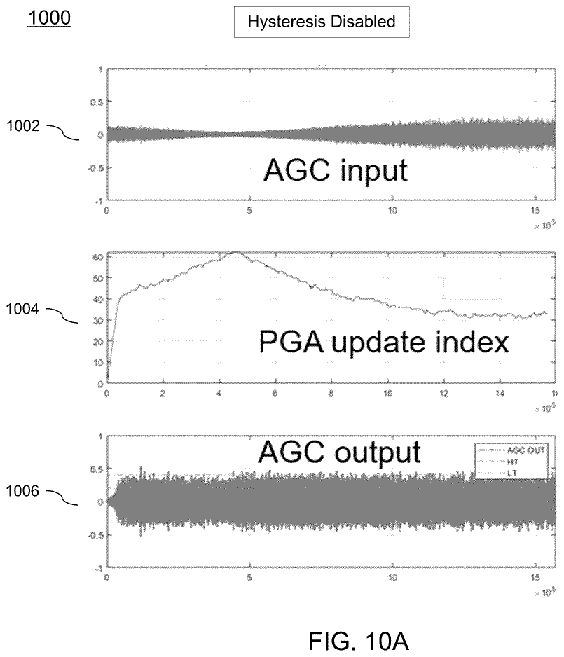

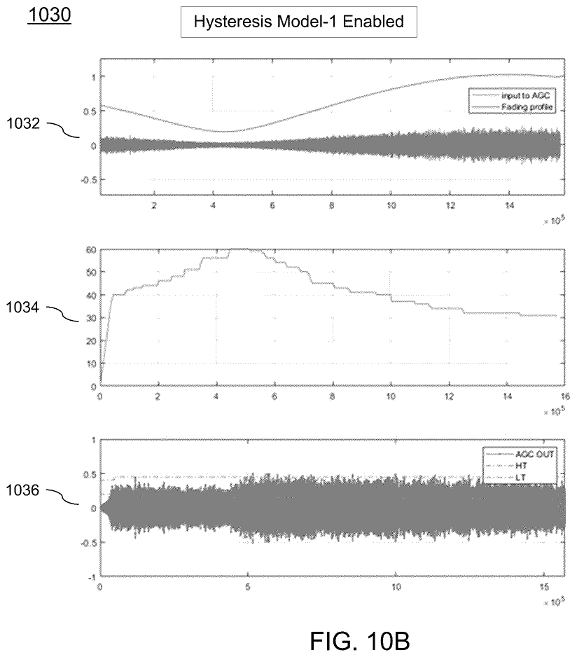

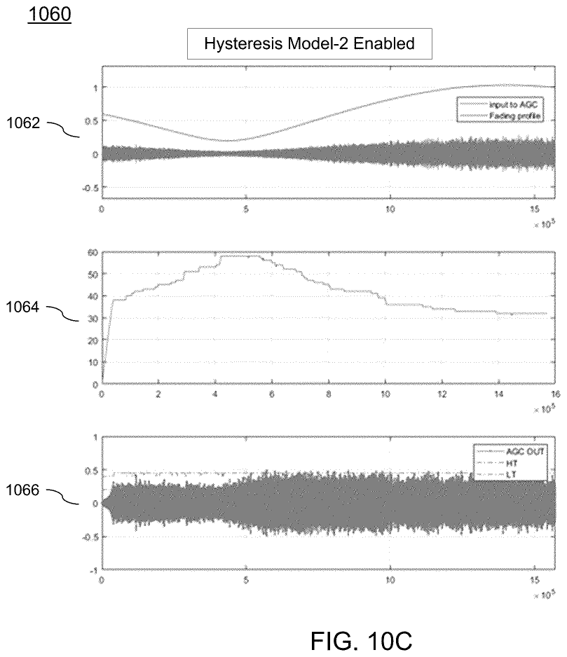

FIG. 10A to FIG. 10C are diagrams depicting example simulation results of RX AGC operations with different modes, according to one or more embodiments. FIG. 10A to FIG. 10C show simulation results showing comparison of three AGC Hysteresis modes: (1) AGC without hysteresis mode, (2) hysteresis mode-1 and (3) hysteresis mode-2, respectively. The simulations were conducted with the following configuration: simulation time≈98 μsec, Rayleigh fading channel, carrier frequency fc=6 GHz, radio frequency f_{S}=16 GHz, Vspeed=800 km/h, Doppler frequency=4.4 kHz. The upper diagrams 1001, 1031, 1061 show the received RF signal input at PGA input over a fading channel. The middle diagrams 1002, 1032, 1062 show the PGA update over time. (X axis shows the time instant 1/16 GHz). The lower diagrams 1003, 1033, 1063 show the PGA output while AGC is in the tracking mode.

Table 1 shows comparison of the PGA update counts over the simulation time of 98 microseconds between different hysteresis modes including (1) AGC without hysteresis mode, (2) hysteresis mode-1, and (3) hysteresis mode-2. A lower PGA update count is desirable to avoid unnecessary gain transitions caused by fading channel samples during the AGC tracking mode. When hysteresis mode is disabled, the PGA update count is 167 because any fluctuation in the AGC input prompts the AGC to react and update the PGA (DVGA). In contrast, the PGA update counts for hysteresis mode-1 and hysteresis mode-2 are 89 and 92, respectively, because enabling hysteresis mode-1 or hysteresis mode-2 can prevent unnecessary PGA updates due to minor signal amplitude variations over the fading channel.

TABLE 1
Comparison of AGC update with/without Hysteresis modes

| | | Hysteresis | Hysteresis |
|---|---|---|---|
| | Hysteresis | Mode-1 | Mode-2 |
| | Disabled | Enabled | Enabled |
| PGA update count | 167 | 89 | 92 |
| (i.e., total number of | | | |
| request for index | | | |
| up/down) | | | |

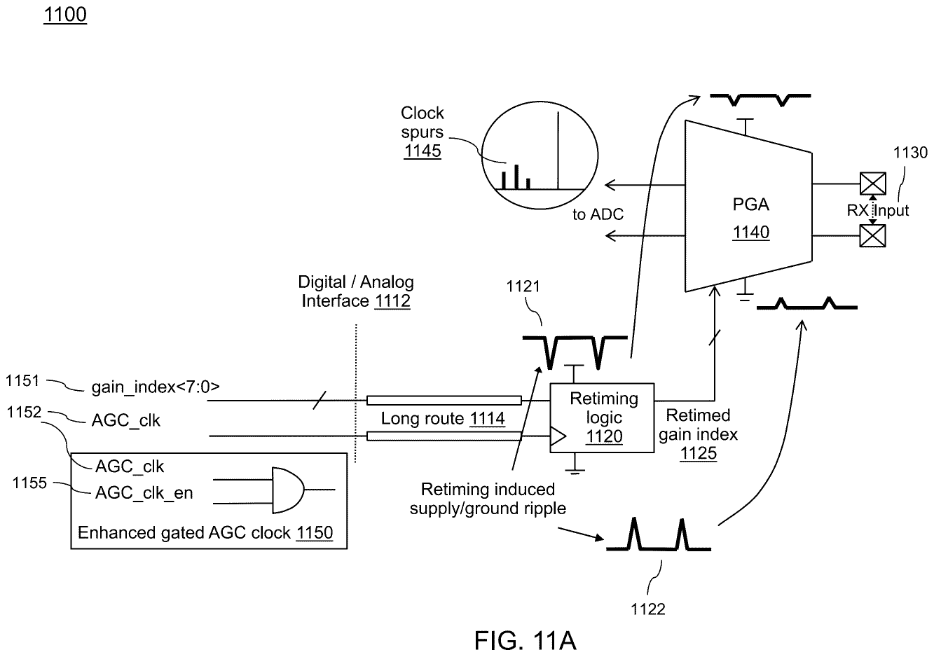

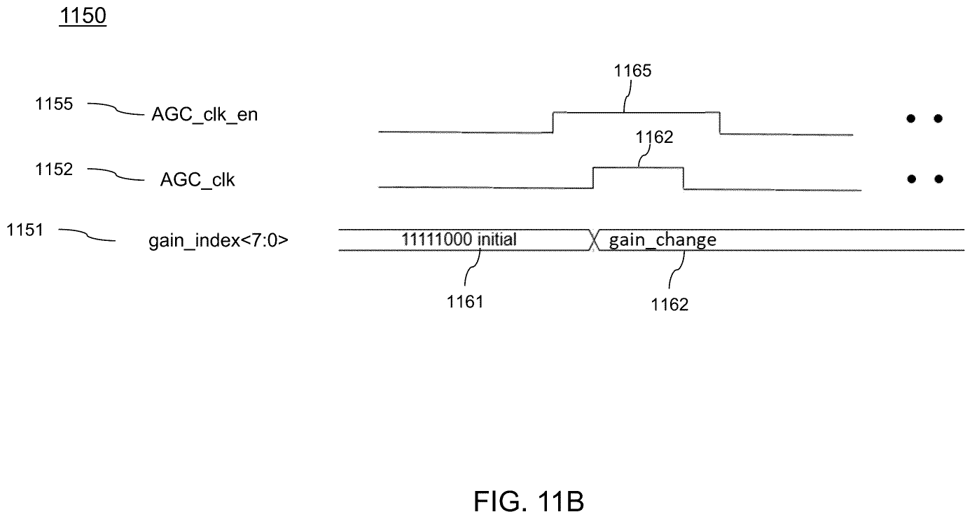

FIG. 11A is a diagram depicting an example gated AGC clock with enhanced receiver spur performance, according to one or more embodiments. In one aspect, a system 1100 (e.g., AGC subsystem) can suffer from clock coupling spurs 1145 induced by a supply ripple 1121 and/or a ground ripple 1122 of a constant AGC clock. The system 1100 may receive a gain index value 1151 (e.g., a 8 bit binary value) and adjust the gain of a PGA 1140 based on the gain index value 1151 according to an AGC clock 1152. In some cases, the gain index value 1151 and the AGC clock 1152 may be provided to a retiming logic 1120 (e.g., retiming logic circuit) through a long route 1114 from a digital/analog interface 1112. The retiming logic 1120 may induce a supply ripple 1121 and/or a ground ripple 1122. When the retiming logic 1120 provides a retimed gain index 1125 to the PGA 1140, the PGA 1140 may generate an amplified signal of an RX input signal 1130. Due to the supply ripple 1121 and/or the ground ripple 1122, the PGA 1140 may generate clock spurs 1145 which may significantly degrade the receiver spurious-free dynamic range (SFDR) performance. For example, running AGC update may impact receiver performance due to continuous AGC clock coupling induced by the retiming logic supply ripple and/or ground ripple.

To address this problem, the system 1100 can provide an enhanced gated AGC clock 1150 that can remove such a coupling, thereby improving receiver spur performance during the AGC update. FIG. 11B is a diagram depicting example clock signals when using the gated AGC clock 1150 shown in FIG. 11A. Referring to FIG. 11B, the system 1100 can enable the AGC clock 1152 only during AGC update 1165 using an AGC clock enable signal 1155. The AGC clock enable signal 1155 can be used to gate and select the updating moment 1165 when the AGC gain index (or gain code) 1151 is changed (e.g., from a gain value 1161 to an updated gain value 1163). This enhancement can avoid the aforementioned spurs by removing the coupling to the receiver signal.

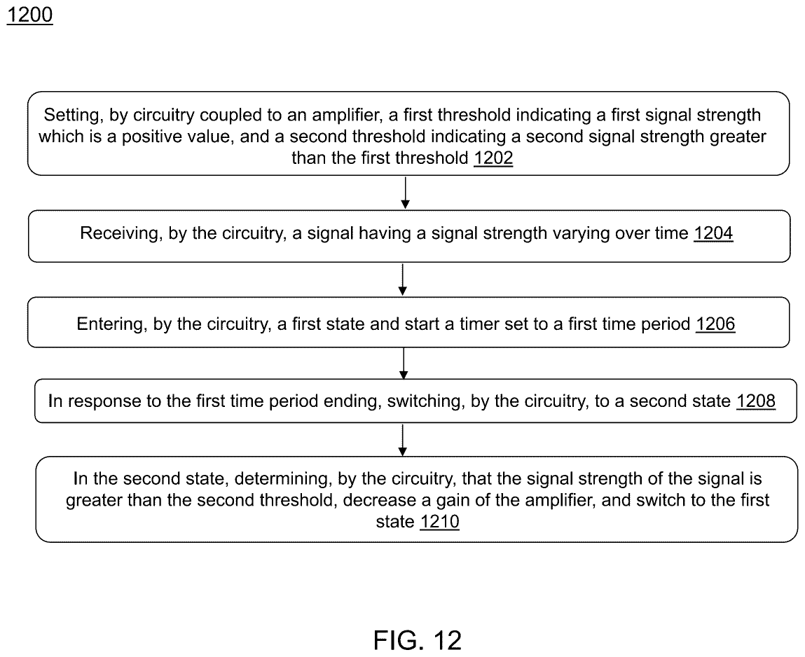

FIG. 12 is a flow diagram showing a process 1200 for processing one or more signals (e.g., performing AGC operations) using hysteresis functions with state machines (e.g., state machines 600, 700) in accordance with an embodiment. In some implementations, the process 1200 is performed by circuitry (e.g. receiver circuitry 140, baseband circuitry 150, processor 2010, AGC circuitry 344, 520) and/or an amplifier (e.g., DVGA 346, VGA 550) of communication system (e.g., communication system 108). In other embodiments, the process 1200 is performed by other entities (e.g., circuitry other than the circuitry of the communication system 108). In some implementations, the process 1200 includes more, fewer, or different steps than shown in FIG. 12. Here, the term “amplifier” refers to one or more voltage amplifiers, one or more current amplifiers, one or more power amplifiers, one or more operational amplifiers, one or more audio amplifiers, one or more RF amplifiers, one or more instrumentation amplifiers, one or more servo amplifiers, or any electronic device that increases the magnitude of a signal, which can be a voltage, current, or power signal.

At step 1202, the circuitry (e.g., AGC 344, 520), which may be coupled to the amplifier (e.g., DVGA 346, VGA 550), may set a first threshold (e.g., high threshold 401, 651, 751) indicating a first signal strength which is a positive value, and a second threshold (e.g., high hysteresis threshold 402, 652, 752) indicating a second signal strength greater than the first threshold. Here, the term “signal strength” refers to an amplitude, a magnitude, a strength, an intensity of an electromagnetic signal, or any power level of an electromagnetic signal as the signal is received by a device.

At step 1204, the circuitry may receive a signal (e.g., signal 405) having a signal strength varying over time. At step 1206, the circuitry may enter a first state and start a timer set to a first time period. Here, the term “state” refers to a current status of a system, a current status that determines how the system responds to inputs or events, or any specific condition or situation that the system can be in at any given moment. The term “timer” refers to an analog circuit to measure time intervals, a digital circuit to measure time intervals, a programmable timer, a countdown timer, an asynchronous counter, a synchronous counter, an up counter, a down counter, an up/down counter, a decade counter, a binary counter, a ring counter, a Johnson counter, or any device that counts down or up to measure time intervals and/or control the operation of other devices based on the elapsed time. Referring to FIG. 6C, the circuitry may enter a first state (e.g., H-Stable state 612) and start a timer (e.g., high timer 655) set to a first time period. Referring to FIG. 7B, the circuitry may enter a first state (e.g., stable state 712) and start a timer (e.g., timer 775) set to a first time period.

At step 1208, in response to the timer being expired (e.g., in response to the first time period ending), the circuitry may switch to a second state. Referring to FIG. 6C, in response to the timer (e.g., high timer 655) being expired, the circuitry may switch to a second state (e.g., H-Idle state 610). Referring to FIG. 7B, in response to the timer (e.g., timer 775) being expired, the circuitry may switch to a second state (e.g., stable state 712).

At step 1210, in the second state, the circuitry may determine that the signal strength of the signal is greater than the second threshold, decrease a gain of the amplifier, and switch to the first state. Here, the term “gain” refers to a voltage gain, a current gain or a power gain of an amplifier, or any measure of how much the amplifier increases a strength of a signal. Referring to FIG. 6C, in the second state (e.g., H-Idle state 610), the circuitry may determine that the signal strength of the signal is greater than the second threshold (e.g., high hysteresis threshold 652), decrease a gain of the amplifier, and switch to the first state (e.g., H-Stable state 612). Referring to FIG. 7B, in the second state (e.g., stable state 712), the circuitry may determine that the signal strength of the signal is greater than the second threshold (e.g., high hysteresis threshold 752), decrease a gain of the amplifier, and switch to the first state (e.g., idle state 710).

In some implementations, the circuitry may be configured to determine that the signal strength of the signal is greater than the first threshold before the timer expires (e.g., before the first time period ends), and restart the timer while remaining in the first state. In some implementations, in the second state, the circuitry may be configured to determine that the signal strength of the signal is less than or equal to the second threshold, and remain in the second state.

Referring to FIG. 6C, the circuitry may be configured to determine that the signal strength of the signal is greater than the first threshold (e.g., high threshold 651) before the timer (e.g., high timer 655) expires, and restart the timer while remaining in the first state (e.g., H-Idle state 610). In some implementations, in the second state (e.g., H-Stable state 612), the circuitry may be configured to determine that the signal strength of the signal is less than or equal to the second threshold (e.g., high hysteresis threshold 652), and remain in the second state (e.g., H-Stable state 612). Referring to FIG. 7B, the circuitry may be configured to determine that the signal strength of the signal is greater than the first threshold (e.g., low threshold 771) before the timer (e.g., timer 775) expires, and restart the timer while remaining in the first state (e.g., idle state 710). In some implementations, in the second state (e.g., stable state 712), the circuitry may be configured to determine that the signal strength of the signal is less than or equal to the second threshold (e.g., high hysteresis threshold 752), and remain in the second state (e.g., stable state 712).

In some implementations, referring to FIG. 7B, the circuitry may be configured to set a third threshold (e.g., low threshold 751) indicating a third signal strength less than the first signal strength, and a fourth threshold (e.g., low hysteresis threshold 752) indicating a fourth signal strength which is less than the third signal strength. In the second state (e.g., stable state 712), the circuitry may be configured to determine that the signal strength of the signal maintains to be less than the fourth threshold (e.g., low hysteresis threshold 752) for a second period of time (e.g., time period set by the decay timer), increase the gain of the amplifier, and switch to the first state (e.g., idle state 710). In some implementations, the circuitry may be configured to determine that the signal strength of the signal maintains to be less than the third threshold (e.g., low threshold 771) for the second period of time (e.g., time period set by the decay timer) before the timer (e.g., timer 775) expires (e.g., before the first time period ends), and restart the timer while remaining in the first state (e.g., idle state 710). In some implementations, in the second state (e.g., stable state 712), the circuitry may be configured to determine that the signal strength of the signal is greater than or equal to the fourth threshold (e.g., low hysteresis threshold 752), and remain in the second state (e.g., stable state 712).

In some implementations, referring to FIG. 6B, the circuitry may be configured to set a fifth threshold (e.g., low threshold 651) indicating a fifth signal strength which is less than the first signal strength, and a sixth threshold (e.g., low hysteresis threshold 652) indicating a sixth signal strength less than the fifth threshold. The circuitry may be configured to enter a third state (e.g., L-Idle state 640) and start a second timer (e.g., low timer 675) set to a third time period. In response to the second timer being expired (e.g., in response to the third time period ending), the circuitry may be configured to switch to a fourth state (e.g., L-Stable stable 642). In the fourth state, the circuitry may be configured to determine that the signal strength of the signal maintains to be less than the sixth threshold (e.g., low hysteresis threshold 652) for a fourth time period (e.g., decay time period set by the decay timer 635), increase the gain of the amplifier, and switch to the third state (e.g., L-Idle state 640). In some implementations, the fourth time period (e.g., decay time period set by the decay timer 635) may be less than the third time period (e.g., time period set by the low timer 675). In some implementations, the circuitry may be configured to determine that the signal strength of the signal maintains to be less than the fifth threshold (e.g., low threshold 651) for the fourth time period (e.g., decay time period set by the decay timer 635) before the second timer expires (e.g., before the third time period ends), and restart the second timer (e.g., low timer 675) while remaining in the third state (e.g., L-Idle state 640). In some implementations, in the fourth state (e.g., L-Stable stable 642), the circuitry may be configured to determine that the signal strength of the signal is greater than or equal to the sixth threshold (e.g., low hysteresis threshold 652), and remain in the fourth state (e.g., L-Stable stable 642).

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It should be noted that certain passages of this disclosure can reference terms such as “first” and “second” in connection with subsets of transmit spatial streams, sounding frames, response, and devices, for purposes of identifying or differentiating one from another or from others. These terms are not intended to merely relate entities (e.g., a first device and a second device) temporally or according to a sequence, although in some cases, these entities can include such a relationship. Nor do these terms limit the number of possible entities (e.g., STAs, APs, beamformers and/or beamformees) that can operate within a system or environment. It should be understood that the systems described above can provide multiple ones of any or each of those components and these components can be provided on either a standalone machine or, In some implementations, on multiple machines in a distributed system. Further still, bit field positions can be changed and multibit words can be used. In addition, the systems and methods described above can be provided as one or more computer-readable programs or executable instructions embodied on or in one or more articles of manufacture, e.g., a floppy disk, a hard disk, a CD-ROM, a flash memory card, a PROM, a RAM, a ROM, or a magnetic tape. The programs can be implemented in any programming language, such as LISP, PERL, C, C++, C#, or in any byte code language such as JAVA. The software programs or executable instructions can be stored on or in one or more articles of manufacture as object code.

While the foregoing written description of the methods and systems enables one of ordinary skill to make and use embodiments thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. An apparatus for processing one or more signals, comprising:
an amplifier; and
circuitry coupled to the amplifier and configured to:
set a first threshold indicating a first signal strength which is a positive value, and a second threshold indicating a second signal strength greater than the first threshold;
receive a signal having a signal strength varying over time;
enter a first state and start a timer set to a first time period;
in response to the first time period ending, switch to a second state; and
in the second state, determine that the signal strength of the signal is greater than the second threshold, decrease a gain of the amplifier, and switch to the first state.

2. The apparatus of claim 1, wherein the circuitry is configured to:
determine that the signal strength of the signal is greater than the first threshold before the first time period ends, and restart the timer while remaining in the first state.

3. The apparatus of claim 1, wherein the circuitry is configured to:
in the second state, determine that the signal strength of the signal is less than or equal to the second threshold, and remain in the second state.

4. The apparatus of claim 1, wherein the circuitry is configured to:
set a third threshold indicating a third signal strength less than the first signal strength, and a fourth threshold indicating a fourth signal strength which is less than the third signal strength;
in the second state, determine that the signal strength of the signal maintains to be less than the fourth threshold for a second period of time, increase the gain of the amplifier, and switch to the first state.

5. The apparatus of claim 4, wherein the circuitry is configured to:
determine that the signal strength of the signal maintains to be less than the third threshold for the second period of time before the first time period ends, and restart the timer while remaining in the first state.

6. The apparatus of claim 4, wherein the circuitry is configured to:
in the second state, determine that the signal strength of the signal is greater than or equal to the fourth threshold, and remain in the second state.

7. The apparatus of claim 1, wherein the circuitry is configured to:
set a fifth threshold indicating a fifth signal strength which is less than the first signal strength, and a sixth threshold indicating a sixth signal strength less than the fifth threshold;
enter a third state and start a second timer set to a third time period;
in response to the third time period ending, switch to a fourth state; and
in the fourth state, determine that the signal strength of the signal maintains to be less than the sixth threshold for a fourth time period, increase the gain of the amplifier, and switch to the third state.

8. The apparatus of claim 7, wherein the fourth time period is less than the third time period.

9. The apparatus of claim 7, wherein the circuitry is configured to:
determine that the signal strength of the signal maintains to be less than the fifth threshold for the fourth time period before the third time period ends, and restart the second timer while remaining in the third state.

10. The apparatus of claim 7, wherein the circuitry is configured to:
in the fourth state, determine that the signal strength of the signal is greater than or equal to the sixth threshold, and remain in the fourth state.

11. A method for processing one or more signals, comprising:
setting, by circuitry coupled to an amplifier, a first threshold indicating a first signal strength which is a positive value, and a second threshold indicating a second signal strength greater than the first threshold;
receiving, by the circuitry, a signal having a signal strength varying over time;
entering, by the circuitry, a first state and start a timer set to a first time period;
in response to the first time period ending, switching, by the circuitry, to a second state; and
in the second state, determining, by the circuitry, that the signal strength of the signal is greater than the second threshold, decrease a gain of the amplifier, and switch to the first state.

12. The method of claim 11, further comprising:
determining that the signal strength of the signal is greater than the first threshold before the first time period ends, and restarting the timer while remaining in the first state.

13. The method of claim 11, further comprising:
in the second state, determining that the signal strength of the signal is less than or equal to the second threshold, and remaining in the second state.

14. The method of claim 11, further comprising:
setting a third threshold indicating a third signal strength less than the first signal strength, and a fourth threshold indicating a fourth signal strength which is less than the third signal strength;
in the second state, determining that the signal strength of the signal maintains to be less than the fourth threshold for a second period of time, increasing the gain of the amplifier, and switching to the first state.

15. The method of claim 14, further comprising:
determining that the signal strength of the signal maintains to be less than the third threshold for the second period of time before the first time period ends, and restarting the timer while remaining in the first state.

16. The method of claim 14, further comprising:
in the second state, determining that the signal strength of the signal is greater than or equal to the fourth threshold, and remaining in the second state.

17. The method of claim 11, further comprising:
setting a fifth threshold indicating a fifth signal strength which is less than the first signal strength, and a sixth threshold indicating a sixth signal strength less than the fifth threshold;
entering a third state and starting a second timer set to a third time period;
in response to the third time period ending, switching to a fourth state; and
in the fourth state, determining that the signal strength of the signal maintains to be less than the sixth threshold for a fourth time period, increasing the gain of the amplifier, and switching to the third state.

18. The method of claim 17, wherein the fourth time period is less than the third time period.

19. The method of claim 17, further comprising:
determining that the signal strength of the signal maintains to be less than the fifth threshold for the fourth time period before the third time period ends, and restarting the second timer while remaining in the third state.

20. The method of claim 17, further comprising:
in the fourth state, determining that the signal strength of the signal is greater than or equal to the sixth threshold, and remaining in the fourth state.
